(19) United States
(12) Patent Application Publication
(10) Pub. No.: US 2005/0055229 A1
(43) Pub. Date: Mar. 10, 2005

(54) Automated issue-communication method that significantly improves an organization's safety culture and corporate forthrightness by encouraging the communication of issues and concerns, circumventing middle-management filters while suppressing "whistleblower" creation

(76) Inventor: Charles Ray Jones, Germantown, MD (US)

Correspondence Address: Charles Ray Jones, 13624 Hartsbourne Drive, Germantown, MD, 20874-2828, US

(21) Appl. No.: 10/657,997

(22) Filed: Sep. 9, 2003

(51) Int. Cl. G06F 17/60

(52) U.S. Cl. 705/1; 705/7

(57) ABSTRACT

This invention is a method for soliciting or requiring each individual in an organization (particularly organizations engaged in activities potentially impacting public safety, such as nuclear power plants, refineries, airlines, and space agencies) to report “up the organizational chain-of-command” his or her issues and concerns periodically as well as in specific instances to senior managers, to regulatory bodies, and/or to the public with minimal or no changes or filtering. Such information may be limited to concerns or issues but also might include up to the full range of routine and non-routine information falling within the knowledge or expertise of the individual, such as work completed and planned and any related obstacles to that work. This invention provides a method or approach that causes this range of data to not only bypass potential filters within middle management, it also provides peer validation and an archival record potentially important for the analysis of the root causes of accidents and incidents, for evaluations of regulatory compliance, and to motivate individuals to increase their productivity, personal integrity, and forthrightness. The work-related issues-and-concerns information may be collected, aggregated, integrated, stored, and analyzed as needed to evaluate potential safety, economic, regulatory, and political impacts associated with the issues and concerns raised. What separates this invention from previous art is primarily that it provides a credible, automated means for lower-level workers and managers to communicate effectively with senior managers without mid-level managers in the organization filtering, modifying, or delaying those communications and provides for concurrent peer-review validation of issues and concerns where those issues and concerns might (previously) have led to “whistleblower” status for the originator.

### CROSS-REFERENCE TO RELATED APPLICATIONS

The current invention's methodology promotes organizational openness and communications such as (1) required for the safe operation of critical facilities (including nuclear power plants, industrial facilities, and space agencies) and (2) expected of large corporations where issues of integrity and due diligence are potentially critical to corporate survival. If an effective means of accomplishing these tasks reliably were already available and applied, major disasters, corporate failures, and similar consequences caused by adverse safety cultures and caused by integrity or corruption issues would likely have been avoided. Thus, it is apparent that this inventive area has not previously been addressed.

In addition to this ongoing prior inventive area void, the current invention's methodology is fundamentally contrarian relative to previous communications and management practices, a contrariness that makes it even less likely that the previous art includes the methodology of the current invention. Moreover, similar to the already stated adverse consequences, the recent and continuing failures and events in critical corporate as well as government organizations also attest to a lack of a means for those workers or employees who need an effective method for raising issues and concerns, specifically exemplified by so-called whistleblowers. Since it is clear by the results that prior practice also does not effectively deal with this worker or employee issue-communication problem, the current invention is even more valuable and relevant in that it does deal effectively with this type of problem. Specifically, the current invention provides a means for potential whistleblowers to blow their whistles in a more positive way and with less probability of actually being pejoratively classified as whistleblowers.

The above inventive-void evidence notwithstanding, a search for prior patents potentially related to the current invention resulted in no direct precedent. Also, prior management practices taught in business schools was reviewed, resulting in a realization that much is said but little is accomplished in practical terms toward the goal of “continuous improvement” and the idealistic but hereto-fore unrealistic claim by senior managers that they have “open door policies.” An effective implementation methodology of these and related theories has previously been lacking or unachievable, especially in the area of open communications from lower level workers and employers to senior managers.

Moreover, as regards the many inventions involving unique computer codes and telecommunications systems, the current invention's methodology can be and should be implemented using a wide range of software applications and computer or network hardware. That is, an additional advantage of the current invention is that its new methodology can be licensed and fielded using many different software languages, computer designs, and network architectures without violating any specific, previous, automation-related patent. This flexibility makes it possible to field the current invention quickly, with minimal constraints. The only constraints are those needed to allow similar databases to be created to facilitate data aggregation and integration. Since there are many ways to create and use databases, the current invention claims no unique or necessary benefits from previous programming languages or software algorithms that may be patented inventions or methods.

The previous patents reviewed relative to the current invention were determined to be distinct and not related either in purpose or approach to the current invention. To reach this determination, an online search was conducted and identified several computer or computer system patents related to (search words) organization, management, culture, reports, issues, concerns, problems, and safety. Finding such computer related inventions is a result that appears consistent with the fact that the current invention in its most practical form largely relies at least on computer-based automation in general. The potentially most closely related previous patents were reviewed relative to the current invention and are listed and discussed below, with their associated abstracts. The comments are intended to suggest how the current invention is different and distinct in purpose and approach.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### REFERENCE TO SEQUENCE LISTING, A TABLE, OR A COMPUTER PROGRAM LISTING COMPACT DISK APPENDIX

Not applicable. There are multiple ways of implementing the methods of the current invention. These ways are best pursued under an appropriate license of the method, which includes requirements to render resulting databases accessible for aggregation and integration across established or new organizations, using existing or new computer systems and networks, and using the appropriate extensible computer languages and data exchange schemas such as XML or using sophisticated relational databases such as those found in SQL Server environments. The absence of a need for a specific computer program or language is a strength of the current invention, and the current invention is best described in terms of the underlying and defining business rules that establish its specific goals and the methodology and functionality needed to meet those goals. These business rules are stated in the detailed description and can be implemented in diverse but essentially equivalent ways.

### BACKGROUND OF THE INVENTION

The methodology of the current invention is based on the personal experience and resulting creative insights of the inventor. This experience is primarily in the field of nuclear plant management and operations, including nuclear power generation plants and nuclear facilities related to the design and production of nuclear weapons and nuclear weapon related systems.

The current invention's broad topical area is familiar to many employees and managers in the nuclear field and is referred to as nuclear safety culture. In the United States, the Nuclear Regulatory Commission (NRC) promotes and regulates a subset of nuclear safety culture referred to as a nuclear facility's Safety Conscious Work Environment (SCWE). Specifically, in an adequate SCWE each worker or manager at a nuclear facility feels free to raise safety-related issues without fear of retaliation, including raising safety issues directly to the NRC.

Unfortunately, experience shows that individuals who raise issues in a way that circumvents the responsible organizational chain of command often are targets of negative reactions from that organization and are often referred to pejoratively as whistleblowers. Moreover, the NRC itself suffers from the inability of individuals within its own staff to comfortably raise issues to senior management, much like other government and corporate organizations. While the NRC has a Differing Professional Opinion Program, employees who use that program are at risk of being viewed by middle and upper managers as troublemakers, and their careers become vulnerable, much like what often happens to whistleblowers in general.

In addition to the highly visible and often counterproductive whistleblower situation or scenario is the much more common situation where a worker at or near the bottom of an organizational structure knows that a problem or unresolved issues exists and is simply not able to communicate the worker's concerns to the responsible senior managers due to middle manager obstructionism or filtering of the worker's stated or written concerns. Organizational filtering of an issue occurs when even a single manager in the chain of command chooses not to forward information up the chain of command. That is, for an issue to be raised to the top of an organization, every manager in the associated chain of command must agree to forward the issue up the chain of command. Due to the nature of many issues, there is likely to be someone in the chain of command who will choose not to forward an issue up the chain of command. Also, the forwarding process itself can cause the communication of an issue or concern to be untimely.

Historically, to try to overcome these problems, top managers in many organizations have stated an open-door policy, which is intended to encourage all of the people who care to do so to come directly to the top manager's office with their concerns and issues. In practice, such an open door policy is not practical and can still lead to adverse consequences for those who attempt to take advantage of it. There is simply not enough room on a senior manager's calendar to allow periodic or frequent direct access by each worker. Even if there were enough time, the fact that the worker talked directly to the senior manager would be evident, making it more likely that retaliation from middle managers would occur.

To provide more privacy for workers who want to raise issues to the senior manager, the current invention provides among other advantages a communications methodology under which workers and other personnel in the organization are encouraged and even required to take their issues and concerns to top managers electronically, bypassing middle managers. This is much like a classic open door policy, but it does not matter whether the senior manager has enough time and energy to personally deal with each communication. The computer software enhances the interface with the senior manager to increase efficiency to the extent feasible, but the mere presence of the system serves to eliminate middle manager filters since such middle managers have no control over what the senior manager knows about issues throughout the organization, and the middle manager may rightly assume that the senior manager(s) are already informed. This fact also encourages better communications between the workers and middle managers, causing everyone to focus on resolving the issues rather than suppressing them.

The mentioned open-door practicality issue is overcome since the senior manager is free to read everything or nothing, and middle managers can no longer assume senior managers do not have access to the issues or concerns raised by subordinates of the middle managers. Also, the information flow is much less subject to delays and may be provided either anonymously or with peer-review validation. Thus, middle managers are motivated to access the issues-and-concerns database and take appropriate action in a more timely manner. In high-risk organizations such as nuclear power plants and space agencies, this has the beneficial effect of focusing limited resources on resolving problems rather than avoiding them while concurrently empowering the engineers and technicians who are closest to and better understand technical matters.

For example, if this current invention's methods had been in place, the destruction of the Challenger and the Columbia space shuttles would arguably have been much less likely.

There are many other similar but less well known events and situations in the inventor's primary area of expertise, the nuclear reactor and nuclear weapon industries, that could have also been avoided. Moreover, the current invention virtually eliminates (but at least strongly discourages) false reporting and report whitewashing by organizational middle managers.

In many high-risk industries such as nuclear power, there are already programs in place that are intended to assist in identifying and tracking emergent equipment problems as well as general issues and concerns. For example, most nuclear power plants already encourage employees to submit what are referred to as condition reports (CR), one for each discrete issue or concern, and most of the CR's are created, tracked, managed, closed, and archived using modern automation software and hardware.

Nuclear plant CR programs can not incorporate all of the current invention capabilities, but they could be upgraded to incorporate some of the advantages and benefits of the current invention methodology. Specifically, CR programs could incorporate unfettered peer reviews that increase issue or concern credibility and reduce the vulnerability of the organization to developing a confrontational whistleblower mentality over any specific issue or concern identified by an individual. With or without peer reviews, many of these diversely created CR programs could also be improved by allowing anonymous submissions and supporting the transmission of all issues and concerns raised to the current invention's industry database for integration and aggregation, the reports from which are to be used by regulatory and other stakeholders.

Nevertheless, even if peer reviews and anonymity were added to systems like the nuclear industry CR programs, it would be far more difficult for such programs to include proactive, periodic inputs on specific issues or concerns from anyone in the organization since that would obscure and defeat the intended management utility of those programs. The new, current invention methodology could provide links to existing programs and data for reference information, but this is an obvious option and not a necessary component or capability of the current invention.

### BRIEF SUMMARY OF THE INVENTION

The current invention goes beyond the previous systems, approaches and programs that are intended to keep senior managers and regulators informed of issues and concerns of lower level workers and managers, such as the nuclear industry's condition reporting programs. The current invention is a proactive means of enabling and possibly requiring each individual or key individuals in an organization to report periodically and in specific, emergent instances to senior managers both critical and routine information, including up to the full range of routine and non-routine information falling within the expertise of the individual. This more complete range of data not only bypasses potential filters within middle management, it also does so in a timelier manner and without diminishing existing responsibilities. Moreover, the current invention provides an archival record potentially important for the analysis of the root causes of accidents and incidents, for personnel performance evaluations, for evaluations of regulatory compliance, and to motivate individuals to increase their productivity.

Under this new invention, the needed computer software and network hardware are provided either by senior management or by an independent organization from within the capabilities of the current computer software and telecommunications art. Management or the independent organizations would use the current invention to allow or require all of the subordinate managers and workers to submit (periodically or in specific cases) their concerns or issues to senior management, to regulators, or even to the public. This would circumvent middle-manager filtering opportunities and would result in faster communications of issues and concerns to senior management and others.

The complete implementation of the entire methodology includes requiring routine (e.g., monthly) reporting from each member of the organization, including those who are temporary consultants and contractors, such that each person summarizes work accomplished, work planned, and their issues and concerns to senior management. Moreover, complete implementation includes automated peer-review and comment such that issues and concerns raised by a single lower level worker or manager can be validated by additional knowledgeable persons, an approach that increases credibility while reducing the likelihood of retaliation (avoids the creation of individual whistleblowers). Moreover, the peer-review validation approach discourages malevolent individuals (assuming that they have access to the system) while providing encouragement to those who want to improve the organization.

Another beneficial result of using this new invention methodology in its full implementation is that those middle managers who might otherwise be inclined to avoid passing or relaying an issue or concern up the chain of command will have to assume that the issue or concern is already available to senior managers, can not be avoided, and must be addressed. Indeed, middle managers are expected to use the same system to summarize and address all issues under their cognizance such that senior managers and other interested parties have both the inputs from the originators and from all the applicable middle managers who may be responsible for addressing issues raised, whether those middle managers are in the originator's chain of command or not.

### DETAILED DESCRIPTION OF THE INVENTION

There are several key attributes of this new invention's information system design business rules. Programmers can create user-specific applications that incorporate some or all of these business rules, as defined under a controlling licensing agreement. The high-level business rules define the overall characteristics of the most common implementation of the current invention's methodology. The high-level business rules are stated below.

The system for each organization must be uniquely tailored software and hardware that collects and provides to senior management and other stakeholders (such as regulatory or oversight entities) the periodic or special reports expected from lower level workers and managers in the organization.

Using the invention's data collection screen or form (typically a data-entry form for a relational database) as implemented for the organization, the originating author or authors of such periodic or special reports may choose to be anonymous, and they may or may not choose to include peer reviews of issues and concerns that may or may not be included in the said reports.

The report form is preferably fully automated for report data collection, and the collected data are automatically deposited in one or more databases for further processing and analysis on behalf of senior managers or other stakeholders, as needed.

The issues-and-concerns databases for the organization as well as those for other similar organizations may also be made available for consolidation within a parent organization or within larger groupings such as an entire industry. For example, participating nuclear power plant organizations might choose to integrate their report databases for the entire corporate fleet of nuclear power plants, and the Nuclear Regulatory Commission (NRC) might choose to integrate the report databases by geographical region, by reactor design, or by generic technical issue.

Provision is made for issue and concern classifications, addition of comments to specific issues and concerns, topical consolidation of issues and concerns, topical thread tracking, issue and concern disposition, and closure determinations that are controlled by the originator of the issue or concern as a de facto result of the invention's methods. That is, an issue or concern is open until it stops being reported.

The supporting business rules define the details of the new invention's capabilities. The supporting business rules are stated below.

A complete listing of authorized (permanent and temporary) members of the organization is maintained, including customary user names and passwords.

Anonymous membership and access is allowed, but all communications from such members are identified as from an anonymous member, and each such member is assigned a distinct number (001, 002, 003 . . . ), username (anonymous001), and password.

Anonymous member identification is issue or concern based and not relative to an actual individual person, but a person may log on with the anonymous member username and password or initiate a new anonymous identity (username and password), as desired.

Each new data input session from a member (including anonymous members) is permanently identified with the applicable username, submission date, and submission time.

Data regarding each member's general level of experience (years) and areas of expertise (education or trade) are optionally collected and displayable in conjunction with viewing inputs from that member.

The member making data entries can specify whether an entry represents a new issue or concern, addresses previous issues or concerns, or whether the submission is routine.

Issue and concern originators are able to categorize their inputs as potentially highly important or assign some lesser category, including specifying that the submittal is currently viewed as unimportant but has potential to become important later or under certain or unspecified conditions.

Organizational functional area managers and administrators are optionally selectable during report submission using, for example, check boxes that allow the originator to specify an initial distribution list for the routine input or for any issues or concerns.

Each report can be separated into sub-reports containing the routine information and any number of separate issues and concerns, each with a separate distribution list, all of which are referenced to the same original report from that originator.

In addition to the said initial originator-specified distribution, submittals from members are automatically distributed or otherwise made available at least to the senior manager, and may be administratively provided as determined by key words to other key managers, to functional area managers, to regulators, and to interested members of the public.

Originators may designate report or sub-report (for example, issues and concern information) for distribution to either internal organization members or external organization members (including the public, using email addresses).

Any recipient designated by a report originator (or other authorized distributor) and any registered member may respond to a report or sub-report (issue or concern) originator using a reply function, adding to the associated thread.

Non-members receiving said reports or sub-reports by means such as email are allowed to join the organization's external membership through the use of a (provided) registration access code and may be charged a fee, but they are not allowed to use the anonymous report function, which is reserved for the organization's internal members.

For organizations that have not officially subscribed to the system, the workers and other employees may still create an unofficial internal membership using an independent (external) system, such as one accessed through use of the Internet.

All system users, stakeholders, and report or sub-report recipients are themselves able to become internal or external members, as appropriate, may use the system to provide their own original reports, and may provide comments on issues and concerns raised by other members.

Reports and comments from members internal and external sources are kept separate or otherwise identified and are processed such that users may select whether to display internal or external inputs, or both internal and external inputs.

Closure of an issue or concern is processed and displayed for information, but the originator and the initial peer reviewers, if any, must confirm closure and may reopen an issue or concern at any time.

The database and network connectivity is such that closed issues and concerns and their associated threads remain accessible to all current, authorized members.

Organizations may, if approved by the senior manager, officially subscribe to the system as a service, providing specific usernames that constitute the internal organization.

External members and pre-subscription members of the organization may become internal members if authorized by the senior manager or other person delegated that authority by the senior manager.

If an organization is not subscribed to the service provided by the current invention, employees and other stakeholders of that organization may still use the service to submit reports, issues, and concerns as if the organization was actually fully subscribed to the service.

Upon subscription to the service, the pre-prescription submittals such as reports, issues, concerns, and comments remain valid but become (or remain) designated as external inputs unless the originators become internal members under the official organization subscription, at which time their submittals become internal submittals.

New internal members may convert their previous external membership (if any) upon registration to internal membership, and may also convert to external membership at anytime, such as when leaving the organization at the end of employment or contract.

Issues and concerns remain designated as originally designated in terms of internal or external member origination, even if the originating person becomes designated differently.

Each company or organization is specifically identified by common names or stock exchange designations such that each system member, including an external stakeholder or interested party, is able to distinguish precisely which organization is the subject of information received from or otherwise displayed by the system.

To ensure compatibility among systems created under license of this new invention, it is intended that the licensed software developers be contractually constrained to collaborate and coordinate with a central authority regarding database structure and interfaces. In this way, all systems provided to individual organizations or entities can most readily be integrated and consolidated such as within and across industries and geographical, political, or regulatory divisions.

### DRAWINGS

Drawings are not essential to understanding this invention since any associated complexity on common organizational pyramid structures (several layers of management) and common computer programming concepts used to automate the methods disclosed in the invention are readily perceptible to persons skilled in the art of organizational management, computer programming, and telecommunications systems.

1. A new and automated approach or method (using computer programming techniques and related network hardware already within the art) to improve an organization's safety culture and, thus, operational safety by enhancing organizational communications up the chain of command, said method consisting specifically of a means of collecting and communicating issues and concerns from lower level workers and managers wherein all such issues or concerns may be:
initiated by any worker or manager at any time, allowing timely submittals;
specifically solicited or accepted for input on a case-basis or periodically;
submitted with or without originator anonymity;
submitted with or without the approval of other workers, managers, or supervisors;
processed for integration and aggregation by one or more computer software programs designed to manage such issues and concerns;
made available (such as through the use of databases and email) directly to or distributed to senior managers, the public, or regulators;
communicated using either internal organizational or external non-organizational telecommunications paths; and
further processed employing such automated means, computer systems, and telecommunications networks as may be needed for effective information collection, retention, and communication to improve organization safety culture, for organizational evaluations, and for stakeholder evaluations at the industry-level, for political division, or for geographical regions.

2. Claim 1, wherein the computer software program or programs also include a means of peer-review and concurrence, thus increasing issue and concern validity and providing a means of reducing or avoiding reprisals against individual “whistleblowers”, said peer reviews being accomplished by routine computer software means (essentially within the current state of the art) such as by use of
peer identification data fields such as names or employee numbers,
checkboxes or links to related prior or existing issues and concerns; or
inclusion in databases and reports as separate means for screening for peer-review status.
automated means such as database searches using key words and software programs (normally server scripts or direct inputs of keywords by users) to provide online collaboration, including interactive peer-review status prompting for the originator or for others such as the senior managers, the database manager, the regulator, or the public.

3. Claim 1, wherein the computer software program or programs are also designed to aggregate, integrate, summarize, document, produce, or otherwise develop and present such issues and concerns for a sub-organization, for an entire organization, for parent organizations, for an industry, or for a political entity or geographic region wherein
a database of issues and claims is created,
said database may be examined and mined for trends, and
economic, regulatory, operational, and safety related conclusions and decisions may be reached.
